(19) United States
(12) Patent Application Publication
(10) Pub. No.: US 2016/0353653 A1
(43) Pub. Date: Dec. 8, 2016

(54) PLOUGH APPARATUS

(71) Applicant: Ryan Golden, Jay, FL (US)

(72) Inventor: Ryan Golden, Jay, FL (US)

(21) Appl. No.: 14/732,698

(22) Filed: Jun. 6, 2015

(51) Int. Cl. A01B 49/02; A01B 15/02; A01B 15/18; A01B 3/24

(52) U.S. Cl. CPC A01B 49/02; A01B 3/24; A01B 15/02; A01B 15/18

(57) ABSTRACT

A plough apparatus disclosed herein includes generally rectangular frame members, multiple chisel members, and multiple pairs of coulter members. The rectangular frame members are fixedly attached to each other to define a rectangular framework. The chisel members are hingedly connected to a multiple of the rectangular framework, where each chisel member is configured to contact and plough a soil structure to create a seedbed when a traction vehicle pulls the rectangular framework over the soil structure. The pairs of coulter members are fixedly attached to a side of the rectangular framework, where each pair of coulter members is positioned in a linear alignment with each of the chisel members. Each coulter member in each pair is aligned at a predefined angle to the corresponding coulter member, where the seedbed formed by the chisel member is widened as each pair of coulter members is pulled through the ploughed soil structure.

### BACKGROUND

Agricultural land development is an expensive process in farming and comprises forest clearance, soil manipulation with tillage gear, transportation of soil, construction of farm roads, and levelling of soil surfaces, etc. These operations require use of self-propelled and heavy equipment such as tractors with heavy duty ploughs and dozers, high horsepower tractors, chisel ploughs, etc. The tillage operations, defined as machine management of soil, are executed to obtain an anticipated seedbed to provide the finest environment for seed germination and plant growth. Seedbed preparation for farming is performed through primary and secondary tillage operations.

There are many conventional methods for tillage that's been practiced for a long time. The farming equipment is usually pulled through a field via a traction vehicle. The farming equipment may comprise tools to perform various functions on the field, such as fertilizing, opening, closing, cutting, and forming trenches. Optimum tillage to result in a maximum crop yield with least energy consumption would be the goal of seedbed preparation in general. A good seedbed is usually considered to indicate finer particles and greater firmness in the proximity of seeds. The depth up to which tillage operations disrupt the soil can categorize the procedure as shallow, medium or deep. The depth of tillage depends on the crop and soil characteristics and also on the source of energy available. In areas where the conditions are arid and semi-arid with high average soil temperature and dry spells, there is a need to plough the soil, which becomes very hard. A pointed tool, for example, chisel or bar point are used on country plough to break soil without reversing or disturbing crop residue in order to collect and store rain water and reduce wind erosion and evaporation losses.

In humid areas, it is required to have deep tillage supplemented by soil inversion and burying of crop residues. This aids in improving nitrogen fixation in soil and incorporation of biomass. In dry land areas tillage necessities are mainly related with enhanced moisture intake and retention, reduced evaporation and checking of weed growth. Studies have showed that increased infiltration rate and higher crop yields can be achieved under dry land conditions by performing deep tillage via a mould board plough. In short, the suggestions are to do shallow or medium tillage in most conditions. For weed control and increased storage of rain water deep tillage is recommended. Summer ploughing with mould board plough, once in two to three years, to invert the soil, is also recommended. In all these conditions, such as the arid, semi-arid, and humid areas, a wider seedbed is necessary in order to collect and store rain water, reduce wind erosion and evaporation losses, enhance moisture intake and retention, and reduce evaporation and weed growth. A pointed chisel will only provide a narrow seedbed, so there should be a method to widen the narrow bed.

Hence, there is a long felt but unresolved need for a plough apparatus which widens the soil structure enabling the plant's root to grow and penetrate effectively through the soil to find moisture, nutrition, and to have room to grow.

### SUMMARY OF THE INVENTION

The plough apparatus disclosed herein addresses the above stated needs for widening the soil structure, enabling the plant's root to grow and to penetrate effectively through the soil to find moisture, nutrition and to have room to grow. The plough apparatus disclosed herein comprises one or more generally rectangular frame members, multiple chisel members, and multiple pairs of coulter members. The one or more rectangular frame members fixedly attached to each other to define a rectangular framework. The chisel members are hingedly connected to multiple sections of the rectangular framework, where each chisel member is configured to contact and plough a soil structure to create a seedbed when a traction vehicle pulls the rectangular framework over the soil structure. In an embodiment, the chisel members are hingedly connected to the sections of the rectangular framework via spring members.

The pairs of coulter members are fixedly attached to a side of the rectangular framework, where each pair of coulter members is positioned in a linear alignment with each of the chisel members. Each coulter member in each pair is aligned at a predefined angle to the corresponding coulter member, where the seedbed formed by the chisel member is widened as each pair of coulter members is pulled through the ploughed soil structure. In an embodiment, the plough apparatus disclosed herein further comprises one or more hitch receivers fixedly attached to an opposing side of the rectangular framework, where the hitch receivers are configured to be connected to the traction vehicle to pull the plough apparatus forward. In an embodiment, the coulter members are substantially of a disc shape with radial corrugations along a circumference of the disc shape.

### BRIEF DESCRIPTION OF THE DRAWINGS

FIG. 1 exemplarily illustrates a top perspective view of the plough apparatus.

FIG. 2 exemplarily illustrates a top schematic view of the plough apparatus.

FIG. 3 exemplarily illustrates a side view of the plough apparatus, showing the plough apparatus attached to a traction vehicle.

### DETAILED DESCRIPTION OF THE INVENTION

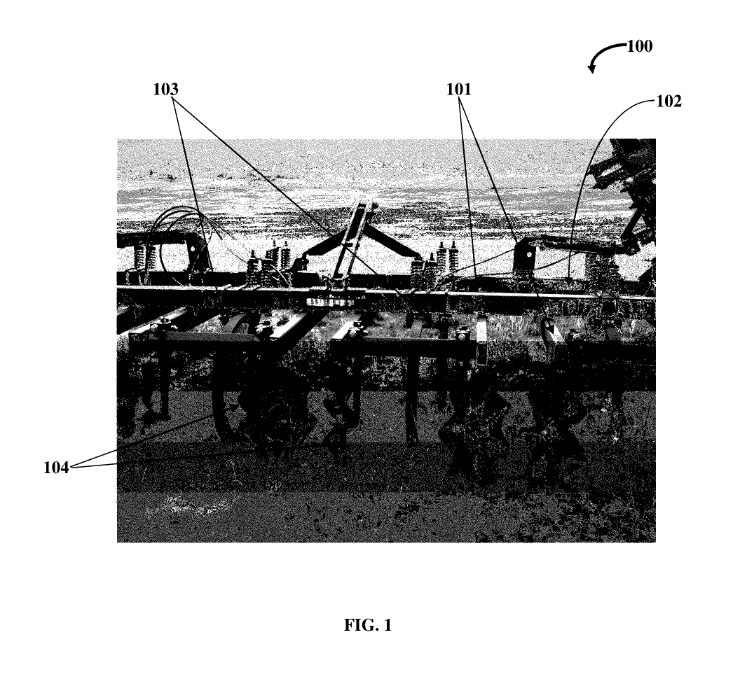

FIG. 1 exemplarily illustrates a top perspective view of the plough apparatus 100. As used herein, the term “plough apparatus” refers to a modified form of a ripper bedder used for agricultural purposes. The rectangular frame members 101 shown in FIG. 1 are generally made of, for example, high grade raw material using advanced tools and equipment. The rectangular framework 102 formed by the rectangular frame members 101 can also be utilized for levelling applications with slight and quick adjustments. The chisel members 103, for example, blade harrows, are attached to the rectangular frame members 101 and are generally used in cutting grass and weed or breaking up of soil clods into smaller particle size. The coulter members 104 is, for example, corrugated plough discs, an agricultural tillage plough disc, a harrow disc, a harrow blade, or a farm disk blade. The coulter member 104 is made of, for example, spring steel with a diameter of, for example, about 24 inches. The coulter member 104 is also heat treated to improve hardness.

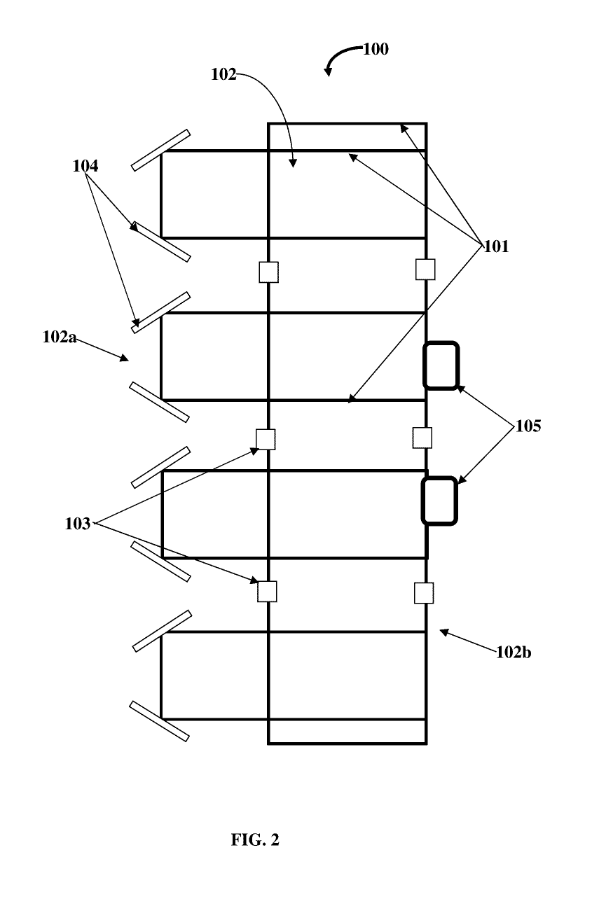

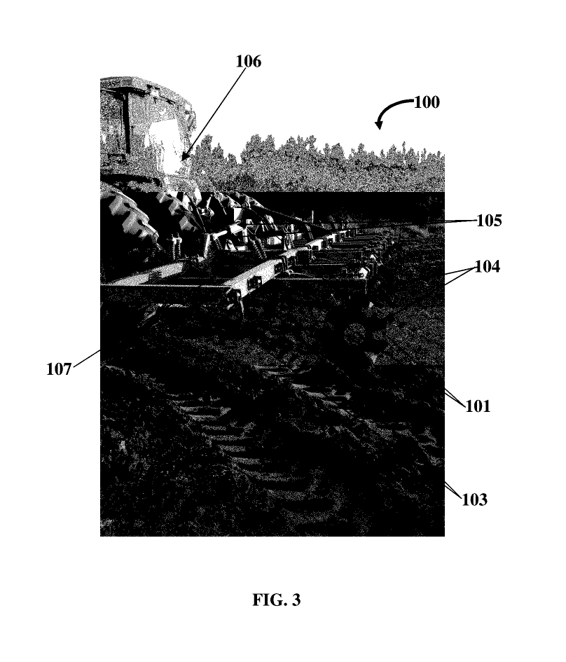

FIG. 2 exemplarily illustrates a top schematic view of the plough apparatus 100. The plough apparatus 100 disclosed herein comprises one or more generally rectangular frame members 101, multiple chisel members 103, and multiple pairs of coulter members 104 comprising wavy coulter blades. One or more rectangular frame members 101 fixedly attached to each other to define a rectangular framework 102. The chisel members 103 are hingedly connected to multiple sections of the rectangular framework 102, where each chisel member 103 is configured to contact and plough a soil structure to create a seedbed when a traction vehicle 106 pulls the rectangular framework 102 over the soil structure as shown in FIG. 3. In an embodiment, the chisel members 103 are hingedly connected to the sections of the rectangular framework via spring members 107 as exemplarily illustrated in FIG. 3.

The pairs of coulter members 104 are fixedly attached to a side 102a of the rectangular framework 102, where each pair of coulter members 104 is positioned in a linear alignment with each of the chisel members 103. Each coulter member 104 in each pair is aligned at a predefined angle to the corresponding coulter member 104, where the seedbed formed by the chisel member 103 is widened as each pair of coulter members 104 is pulled through the ploughed soil structure. In an embodiment, the coulter members 104 are substantially of a disc shape with radial corrugations along a circumference of the disc shape. In an embodiment, the plough apparatus 100 disclosed herein further comprises one or more hitch receivers 105 fixedly attached to an opposing side 102b of the rectangular framework 102 which is further explained in FIG. 3.

FIG. 3 exemplarily illustrates a side view of the plough apparatus 100, showing the plough apparatus 100 attached to a traction vehicle 106. The plough apparatus 100 disclosed herein further comprises one or more hitch receivers 105 fixedly attached to the rectangular framework 102, where the hitch receivers 105 are configured to be connected to a traction vehicle 106 to pull the plough apparatus 100 forward as shown in FIG. 3. In an example, the plough apparatus 100 disclosed herein loosens the seedbed than the standard shank on a ripper bedder, and is much lighter than other ripper bedders. Further, the plough apparatus 100 loosens the ground only at a furrow and throws the soil from the seedbed into a mound or bed that holds moisture for ease of planting. The plough apparatus 100 creates a furrow or seedbed which is wider and looser than the ripper bedders known in the art which allow better moisture absorption and root penetration. The plough apparatus 100 is much lighter other ripper bedders known in the art, therefore the plough apparatus 100 uses less fuel and can be pulled by a smaller traction vehicle 106, for example, a smaller tractor. The plough apparatus 100 loosens a wider swath of soil than other ripper bedders in the art.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

I claim:

1. A plough apparatus comprising:
one or more generally rectangular frame members fixedly attached to each other to define a rectangular framework;
a plurality of chisel members hingedly connected to a plurality of sections of the rectangular framework, each chisel member configured to contact and plough a soil structure to create a seedbed when a traction vehicle pulls the rectangular framework over the soil structure; and
a plurality of pairs of coulter members fixedly attached to a side of the rectangular framework, each pair of coulter members positioned in a linear alignment with each of the chisel members, wherein each coulter member in each pair is aligned at a predefined angle to the corresponding coulter member, wherein the seedbed formed by the chisel member is widened as each pair of coulter members is pulled through the ploughed soil structure.

2. The plough apparatus of claim 1, further comprises one or more hitch receivers fixedly attached to an opposing side of the rectangular framework, wherein the hitch receivers are configured to be connected to the traction vehicle to pull the plough apparatus forward.

3. The plough apparatus of claim 1, wherein the chisel members are hingedly connected to the sections of the rectangular framework via spring members.

4. The plough apparatus of claim 1, wherein the coulter members are substantially of a disc shape with radial corrugations along a circumference of the disc shape.

5. The plough apparatus of claim 1, is made of a light weight material.
